(19) United States
(12) Patent Application Publication
(10) Pub. No.: US 2013/0325505 A1
(43) Pub. Date: Dec. 5, 2013

(54) SYSTEMS AND METHODS FOR POPULATION HEALTH MANAGEMENT

(71) Applicant: General Electric Company, Schenectady, NY (US)

(72) Inventor: Joel Vengco, Norwell, MA (US)

(21) Appl. No.: 13/839,649

(22) Filed: Mar. 15, 2013

Related U.S. Application Data
(60) Provisional application No. 61/653,878, filed on May 31, 2012.

(51) Int. Cl. G06F 19/00; G06Q 50/24

(52) U.S. Cl. CPC G06F 19/322; G06Q 50/24
USPC 705/3

(57) ABSTRACT

Certain examples provide system and methods for population health management. An example population health management system includes an information exchange platform, a knowledge platform, application(s), and a user portal. The example information exchange platform is to share of information for patients and providers in a selected population. The example information exchange platform is to collect and transform the information into an accessible, sharable format. The example knowledge platform is to derive insight from the collected and transformed information. The example knowledge platform is to facilitate application of one or more analytics and rules-based workflows to the collected and transformed information to derive insight. The example application(s) are to coordinate communication and care collaboration across the selection population based on the insight and information. The example user portal is to provide a unified interface to enable access to the application(s), knowledge platform, and information for the selected population.

### RELATED APPLICATIONS

This patent claims the benefit of priority to U.S. Provisional Patent Application No. 61/653,878, filed on May 31, 2012, which is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, which are stored in a medical information system. Radiologist and/or other clinicians may review stored images and/or other information, for example.

Hospitals utilize computer systems to manage the various departments within a hospital and data about each patient is collected by a variety of computer systems. For example, a patient may be admitted to the hospital for a Transthoracic Echo (TTE). Information about the patient (e.g., demographics and insurance) could be obtained by the HIS and stored on a patient record. This information could then be passed to the cardiology department system (e.g., the CVIS), for example. Typically the CVIS is a product of one company, while the HIS is the product of another company. As a result, the database between the two may be different. Further, information systems may capture/retain and send different levels of granularity in the data. Once the patient information has been received by the CVIS, the patient may be scheduled for a TTE in the echo lab. Next, the TTE is performed by the sonographer. Images and measurements are taken and sent to the CVIS server. The reading physician (e.g., an echocardiographer) sits down at a review station and pulls the patient's TTE study. The echocardiographer then begins to review the images and measurements and creates a complete medical report on the study. When the echocardiographer completes the medical report, the report is sent to the CVIS server where it is stored and associated with the patient through patient identification data. This completed medical report is an example of the kind of report that could be sent to a data repository for public data mining. Medication instructions, such as documentation and/or prescription, as well as laboratory results and/or vital signs, may also be generated electronically and saved in a data repository.

Today, medical device manufacturers and drug companies face an ever-growing challenge in collecting clinical data on the real-life utilization of their products. As patient medical reports are becoming computerized, the ability to obtain real-life utilization data becomes easier. Further, the data is easier to combine and analyze (e.g., mine) for greater amounts of useful information.

As medical technology becomes more sophisticated, clinical analysis may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize a full benefit of medical technological growth, it would be highly desirable for clinical information to be organized and standardized.

Even if clinical or image-related information is organized, current systems often organize data in a format determined by developers that is unusable by one or more medical practitioners in the field. Additionally, information may be stored in a format that does not lend itself to data retrieval and usage in other contexts. Thus, a need exists to structure data and instructions in a way that is easier to comprehend and utilize.

Data warehousing methods have been used to aggregate, clean, stage, report and analyze patient information derived from medical claims billing and electronic medical records. Patient data may be extracted from multiple EMR databases located at patient care provider (PCP) sites in geographically dispersed locations, then transported and stored in a centrally located data warehouse. The central data warehouse may be a source of information for population-based profile reports of physician productivity, preventative care, disease-management statistics and research on clinical outcomes. Patient data is sensitive and confidential, and therefore, specific identifying information must be removed prior to transporting it from a PCP site to a central data warehouse. This removal of identifying information must be performed per the federal Health Insurance Portability and Accountability Act (HIPAA) regulations. Any data that is contained in a public database must not reveal the identity of the individual patients whose medical information is contained in the database. Because of this requirement, any information contained on a medical report or record that could aid in tracing back to a particular individual must be removed from the report or record prior to adding the data to a data warehouse for public data mining.

Patient data may be useful to medical advancement, as well as diagnosis and treatment of patients, in a variety of ways. In order to accurately assess the impact of a particular drug or treatment on a patient, for example, it is helpful to analyze all medical reports relating to the particular patient. Removing data that can be used to trace back to an individual patient can make it impossible to group and analyze all medical reports relating to a particular patient. In addition, one of the aims of population analysis is to assemble an at-risk cohort population comprised of individuals who may be candidates for clinical intervention. De-identified data is not very useful to the patient care providers who need to know the identity of their own patients in order to treat them. Users of the system may need the ability to re-identify patients for further follow-up. Portal users may need to re-identify the patients in a process that doesn't involve the portal system, i.e. the process of re-identification occurs on the local user's system.

Efforts are underway nationally to connect healthcare information systems and make them interoperable in a secure, sustainable, and standards-based manner. However, the required information infrastructure is still under development, both for the National Health Information Network (NHIN) led by the federal government, as well as for the many small Regional Health Information Organizations (RHIOs) across the nation. Many challenges remain for health information exchange (HIE) in the United States and elsewhere. For example, financial sustainability models must be determined for construction and operation of NHINs and RHIOs.

### BRIEF DESCRIPTION

Certain examples provide system and methods for population health management.

Certain examples provide a population health management system including an information exchange platform, a knowledge platform, one or more applications, and a user portal. The example information exchange platform is to share of information for patients and providers in a selected population. The example information exchange platform is to collect and transform the information into an accessible, sharable format. The example knowledge platform is to derive insight from the collected and transformed information. The example knowledge platform is to facilitate application of one or more analytics and rules-based workflows to the collected and transformed information to derive insight. The one or more example applications are to coordinate communication and care collaboration across the selection population based on the insight and information. The example user portal is to provide a unified interface to enable access to the one or more applications, knowledge platform, and information for the selected population.

Certain examples provide a computer readable storage medium including instructions to be executed by a processor, the instructions, when executed, to implement a population health management system. The example population health management system includes an information exchange platform, a knowledge platform, one or more applications, and a user portal. The example information exchange platform is to share of information for patients and providers in a selected population. The example information exchange platform is to collect and transform the information into an accessible, sharable format. The example knowledge platform is to derive insight from the collected and transformed information. The example knowledge platform is to facilitate application of one or more analytics and rules-based workflows to the collected and transformed information to derive insight. The one or more example applications are to coordinate communication and care collaboration across the selection population based on the insight and information. The example user portal is to provide a unified interface to enable access to the one or more applications, knowledge platform, and information for the selected population.

Certain examples provide a method for population health management. The example method includes providing access to accumulated patient data and associated analytics for a selected population in conjunction with one or more applications via a user portal. The example method includes monitoring a change in one or more of patient, data, and events based on the accumulated patient data and associated analytics captured from a plurality of sources in the selected population. The example method includes stratifying patients in the selected population into groups based on at least one of need, cost or risk. The example method includes identifying one or more problems and diagnoses associated with each of the stratified patient groups to facilitate management and coordination of patient care within each stratified group. The example method includes facilitating management and coordination of patient care by enabling communication between patients and providers and definition of care pathways with associated goals.

### BRIEF DESCRIPTION OF SEVERAL VIEWS OF THE DRAWINGS

FIG. 1 illustrates an example health information exchange (HIE).

FIG. 2 depicts an example HIE facilitating an exchange of medical quality data.

FIG. 3 illustrates a flow diagram for an example method to provide health information exchange services.

FIG. 4 illustrates an example community of care built around an HIE foundation.

FIGS. 5-8 illustrate example population health management systems.

FIG. 9 depicts an example population health management cycle.

FIG. 10 is a block diagram of an example processor platform that may be used to implement systems and methods described herein.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EXAMPLES

Certain examples provide insight into a meaningfully segmented patient population. Certain examples provide access to comprehensive information across time, visits, providers, etc. Certain examples facilitate monitoring of tasks to proactively manage patient care. Certain examples leverage insight and monitoring to affect an organization's cost and quality curve.

Certain examples help facilitate movement from traditional fee for service payment models to global payments; from provider-centric to patient-centric; from reactive to proactive care management; from experiential medical art to evidenced-based scientific medicine; from localized care to community of care, and from episodic patient care to longitudinal population health management. Certain examples help provide openness, information sharing, interoperability, and new solutions beyond electronic medical records (EMR).

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, BLU-RAY®, etc., storing the software and/or firmware.

In certain examples, a healthcare organization's patient population is stratified so that the organization can view the patient population segmented into meaningful categories (e.g., categories having meaning, purpose, significance, and/or value to population health management) rather than isolated episodes of care and singular patients. Rather than partial data views from a single visit to a single provider from a single EMR, users can access comprehensive (e.g., inclusive) information across time, visits, and providers, for example. Certain examples provide proactive monitoring and alerting on tasks and notifications related to patients who required care management rather than reactive procedures or visits that could have been prevented if identified earlier. Certain examples facilitate action by healthcare organizations based on this information to impact cost and quality for the organization's patient population. In certain examples, a health information exchange helps form a foundation to connect a community for population health management.

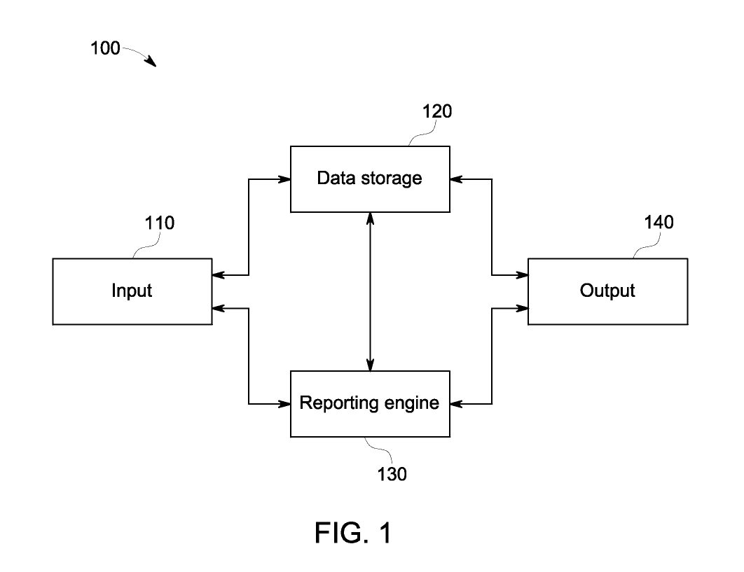

FIG. 1 illustrates an example health information exchange (HIE) 100. The HIE 100 is organized to provide storage, access and searchability of healthcare information across a plurality of organizations. The HIE 100 may service a community, a region, a nation, a group of related healthcare institutions, etc. For example, the HIE 100 may be implemented as and/or implemented with a regional health information organization (RHIO), national health information network (NHIN), medical quality improvement consortium (MQIC), etc. In certain examples, the HIE 100 connects healthcare information systems and helps make them interoperable in a secure, sustainable, and standards-based manner.

The HIE 100 provides a capability to exchange information between both related and disparate healthcare information systems. The HIE 100 helps facilitate access to and retrieval of clinical and other healthcare data with improved safety, timeliness and/or efficiency, etc. Components and/or participants in the HIE 100 adhere to a common set of principles and standards for information sharing within a provided technical infrastructure, for example. The HIE 100 may be used to store, access and/or retrieve a variety of data, including data related to outpatient and/or inpatient visits, laboratory results data, emergency department visit data, medications, allergies, pathology results data, enrollment and/or eligibility data, disease and/or chronic care management data/services, etc.

In certain examples, the HIE 100 helps to provide financial sustainability models for construction and operation of NHINs and/or RHIOs. In certain examples, the HIE 100 helps facilitate standardization and interoperability of healthcare information among participants in exchange network(s). In certain examples, the HIE 100 provides a centralized data architecture. However, in certain examples, the HIE 100 may also utilize a combined centralized yet partially distributed data architecture. Certain examples create an aggregated, patient-centric view of health information. In certain examples, the HIE 100 provides one or more large databases of de-identified population data for quality improvement, care management, research, etc. Through the HIE 100, a patient and/or provider may control information access, privacy, and security, for example.

The HIE 100 includes one or more inputs 110, a data storage 120, a reporting engine 130 and one or more outputs 140. In certain examples, the data storage 120 is a centralized data storage and/or may be subdivided in to a plurality of interconnected data storage. The reporting engine 130 may be used to generate queries, searches and/or other reports based on data in the data storage 120 and one or more requests, parameters, criteria, etc., specified by the input 110 and/or preset in the HIE 100, for example. The one or more inputs 110 may include a variety of informational and/or query sources, such as healthcare facilities, labs, electronic medical record (EMR) systems, healthcare information systems, insurance systems, pharmaceutical systems, etc. The one or more outputs 140 may include one or more web viewers or portals, EMR systems, application service provider (ASP) systems, healthcare information systems, practice management systems, etc. The components of the HIE 100 may be implemented individually and/or in various combinations in software, hardware and/or firmware, for example.

In certain examples, the HIE 100 provides a technical architecture, web applications, a data repository including EMR capability and a population-based clinical quality reporting system, for example. The architecture includes components for document storage, such as the data storage 120, querying, such as the reporting engine 130, and connectivity to data sources, such as input 110 and output 140. The output 140 may include web portal applications for data presentation to physicians and patients, for example. In certain examples, the data repository 120 may include an option for a subscription-based EMR for physicians, for example. In certain examples, the HIE 100 provides a population-based clinical quality improvement and research database with reporting tools, for example.

In certain examples, a financial sustainability model governs these capabilities. Through ASP provision, leasing, licensing, etc., the HIE 100 can generate revenue for data access and storage, for example. The system 100 allows an EMR to be licensed/leased to physicians who do not have an EMR. Thus, physicians may use only minimal information technology (IT) administration to access the EMR. Additionally, the ASP-provided EMR from the HIE 100 includes built-in connectivity to regional data sources and an automated quality/research reporting capability of the data warehouse to which the centralized EMR is connected. Furthermore, using an EMR with ASP access, new technology may be rolled out or distributed regionally and/or otherwise to a physician office, for example.

Using the cross document sharing or XDS standard, for example, in the HIE 100, document querying and storage can be integrated for more efficient and uniform information exchange. Using the HIE 100, quality reporting and research may be integrated in and/or with an RHIO and/or other environment. The HIE 100 provides a single-vendor integrated system that can integrate and adapt to other standards-based systems, for example. The HIE 100 allows a provider to package both existing and new products and/or services for the RHIO and/or other market.

As mentioned above, in certain embodiments, the HIE 100 provides a financial sustainability to a healthcare organization, such as an RHIO. Using EMR application services via the HIE 100, an RHIO can generate revenue streams, for example. Alternatively and/or in addition, use of population-based data from the HIE 100 may be used to create revenue streams for the RHIO, for example.

In certain examples, the HIE 100 helps to facilitate the implementation of an MQIC. Via the HIE 100, a group of EMR users may agree to pool data at the data storage 120. The HIE 100 may then provide the group with access to aggregated data for research, best practices for patient diagnosis and treatment, quality improvement tools, etc. Royalties for the use of data may be generated as compensation, for example.

Through the MQIC and the HIE 100, users may help to improve the quality of healthcare through updated tools and expanded EMR quality improvement reports, for example. The MQIC and the HIE 100 offer members updated clinical information regarding patient illnesses, such as diabetes, heart attack, stroke, hypertension, congestive heart failure, and the like. Data exchange may also be used for clinical research. In certain examples, user may opt in or out of particular projects/collaborations via the HIE 100.

In certain examples, a secure Internet line and/or Web-based portal may be used to access the HIE 100 to participate in a MQIC. In certain examples, the HIE 100 extracts clinical-level patient data on a regular basis (e.g., nightly) from participating EMRs 110 to a centralized data warehouse or other data storage 120. The reporting engine 130 re-formats the data into useful reports in order for physicians and practices to benchmark their performances against a national, regional and/or other database, for example. In certain examples, data collected is HIPAA-compliant with patient-identifying information removed such that only relevant EMR customers can re-identify individual patients. Participating physicians using the HIE 100 can privately run automated population-based reports via a simple Web-based portal, analyzing data from physician office EMR(s). Generated report(s) give physicians assistance to gauge whether their patients are receiving recommended care. Using the local EMR and the HIE 100, physicians and clinical staff may document patient encounters electronically, help to streamline clinical workflow and more securely exchange data with other providers, payors and information systems. Decision support tools may also help inform physicians of harmful drug interactions based on automated medication checking and reminders for tests and/or procedures to help facilitate proactive management of patient health. Using the information and tools provided by the HIE 100, physicians may be enabled to improve process and quality of care, measure clinical performance and/or increase reimbursement for services, for example.

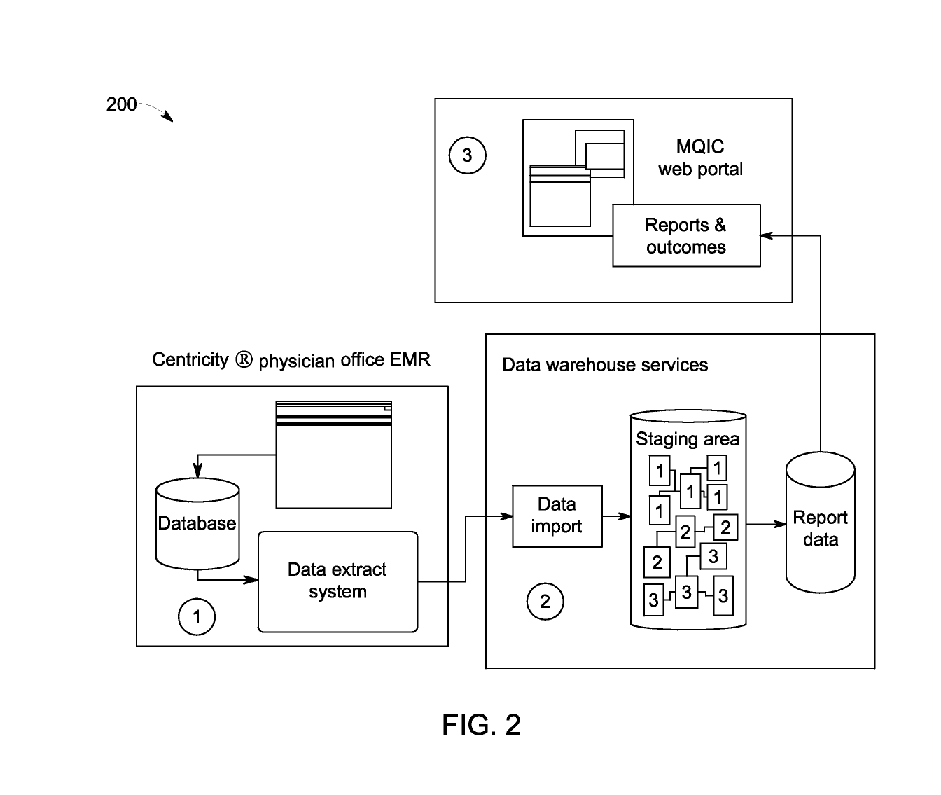

As illustrated in FIG. 2, the HIE 100 may facilitate an exchange of medical quality data (e.g., MQIC) through the extraction of data from one or more local EMRs, the importation and aggregation of the data in a data warehouse, and the generation of reports available to participants via a web portal or EMR. At 1, data input into a local EMR database is extracted. At 2, the extracted data is imported, aggregated and/or otherwise analyzed, and used in generating report data. For example, data may be “cleaned” or normalized to a common grammar or format. At 3, reports and/or other outcomes are provided to participating users via a Web portal. A variety of information, tools and/or other assistance may be offered via the Web-based portal, for example.

In certain examples, a health information architecture provides access for storing, sharing, and analysis of data. Data can include a variety of identified and/or de-identified (e.g., anonymized) patient and/or other clinical data, for example. Data and access security can be provided, for example. Data source(s) may include EMR, radiology, laboratory and/or other clinical data sources, for example. Data query source(s) may include insurers, pharmacies, prescription benefit managers, and/or other services, for example. The components of the health information architecture may be implemented individually and/or in various combinations in software, hardware and/or firmware, for example.

In operation, document sharing may be facilitated by the architecture via a hub. Patient data is passed from one or more sources using an interface standard, such as the standards approved by the Health Information Technology Standards Panel (HITSP) and accepted by the US Department of Health and Human Services (HHS), Health Level Seven (HL7) and/or Digital Imaging and Communications in Medicine (DICOM) communication interface and file format standards, for example. One or more query sources may transmit query information to a query engine using an interface standard, such as the X.12 and/or National Council for Prescription Drug Programs (NCPDP) communication standard or standards approved by HITSP and accepted by HHS. The query engine serves as a message hub and/or switch to route query messages to appropriate repository(ies), for example. A community of one or more physician or other healthcare office systems may store, access, or exchange information in the shared clinical repository, for example.

In certain examples, a Web portal may be used to facilitate access to information, patient care and/or practice management, for example. Information and/or functionality available via the Web portal may include one or more of order entry, laboratory test results review system, patient information, clinical decision support, medication management, scheduling, electronic mail and/or messaging, medical resources, etc. In certain examples, the Web portal serves as a central interface to access information and applications, for example. Data may be viewed through the Web-based portal or viewer, for example. Additionally, data may be manipulated and propagated using the Web portal, for example. Data may be generated, modified, stored and/or used and then communicated to another application or system to be modified, stored and/or used, for example, via the Web portal and HIE hub.

The Web portal may be accessible locally (e.g., in an office) and/or remotely (e.g., via the Internet and/or other private network or connection), for example. The Web portal may be configured to help or guide a user in accessing data and/or functions to facilitate patient care and practice management, for example. In certain examples, the Web portal may be configured according to certain rules, preferences and/or functions, for example. For example, a user may customize the Web portal according to particular desires, preferences and/or requirements.

In certain examples, an XDS profile and/or protocol (e.g., an Integrating the Healthcare Enterprise Cross-Enterprise Sharing of Medical Summaries Integration Profile (IHE XDS-MS) protocol) may be used to define a coupling or connection between one or more entities for patient document sharing. For example, XDS may be used to form a query identifying sources with information about a particular patient and/or other criteria, determining an identifier used to associate clinical data related to the patient and/or other criteria and request patient information from the appropriate source and/or repository, such as an XDS document repository, for example. A record locator service (RLS) may also be used to facilitate sharing of information between organizations, for example.

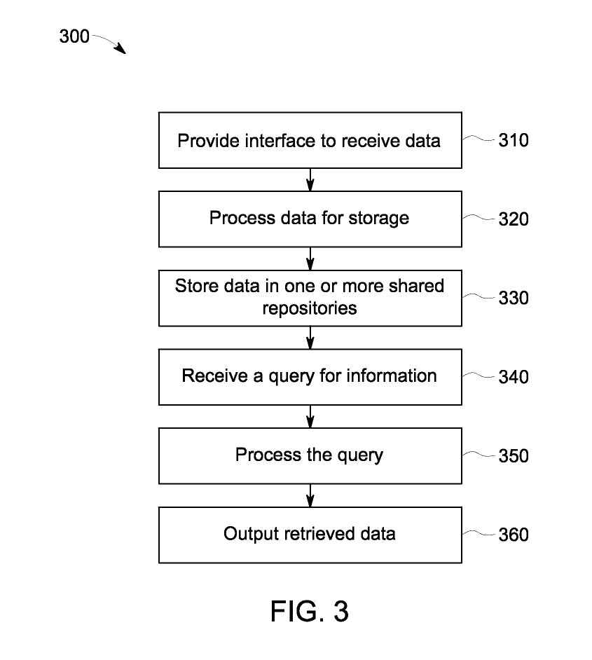

FIG. 3 illustrates a flow diagram for an example method 300 to provide health information exchange services. At block 310, an interface is provided to allow a plurality of data sources to transmit data to one or more shared repositories for storage. At block 320, if applicable, data is processed for storage. For example, data may be formatted, normalized, scrubbed, etc. for storage in a shared data repository. At block 330, data is stored in one or more shared repositories, such as an EMR clinical repository, an XDS document repository, etc.

At block 340, a query for information is received at a query engine. At block 350, the query is processed. For example, a pre-fetching of data and/or other query function may be triggered to locate and retrieve requested data from one or more repositories. At block 360, retrieved data is output. For example, retrieved data may be formatted for display (e.g., Web-based viewing), transmission to a local EMR, output to an ASP-provided office system, etc.

One or more elements of the method 300 may be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device. Certain examples may omit one or more of these elements and/or perform the elements in a different order than the order listed. For example, some elements may not be performed and/or may be performed in a different temporal order than listed above.

In certain examples, fees may be charged. For example, a fee may be charged to allow a user to store data in a shared repository. A fee may be charged to process a query in the health information exchange system, for example. Alternatively and/or in addition, a fee may be charged for a Web viewing application to allow access to and/or manipulation of data output from a repository, for example.

Certain examples enable use of population-based data to create revenue streams for a healthcare organization, such as an RHIO. An EMR-based medical quality data warehouse has a special value for RHIOs seeking to aggregate and compare regional data against national benchmarks. Certain examples provide use of population data from a RHIO and/or other enterprise for clinical quality and outcomes reporting. Certain examples facilitate use of population data from a RHIO and/or other source to create clinical performance metrics at the physician, clinic, enterprise, and regional levels. Certain examples combine information and connectivity to provide access to claims history data, either raw or filtered through quality and decision support tools, to help physicians enhance performance.

In certain examples, population data from a RHIO and/or other shared organization can be used to created clinical performance benchmarks. Population data may also be use to create data sets for pharmacotherapy studies, pharmaceutical outcomes research, pharmacoeconomic research, pharmacoepidemiology, pharmacovigilance, etc. Population data may also be collected from a RHIO and/or other information collection to create data sets for clinical outcomes research, health economic research, clinical epidemiology, and biosurveillance.

Certain examples allow use of re-identified individual patient data from a health information organization to inform chronic disease care management, preventive care, and multi-site care coordination, for example. EMR database information may be used to aggregate, scrub, structure, and/or transform raw clinical data from a RHIO, for example, and load a population data warehouse. Data warehouse exchange-transform-load (ETL) routines may provide de-identification and re-identification capabilities safeguard patient privacy, for example. Data warehouse ETL routines may also provide medication data processing capabilities to create structured and quantitative medication information for each patient prescription, for example. Certain examples provide a quality and outcomes reporting portal based on population data from a health information organization to allow access to clinical performance metrics, benchmarks, and statistics, for example.

Certain examples provide integrated, accountable care of a patient and patient population in conjunction with accountable care organizations/integrated healthcare organizations, etc. Certain examples provide healthcare models to promote accountability and improved outcomes for the health of a defined population. Certain examples facilitate population health management by helping to engage a defined group of patients and providers across a continuum of care.

Certain examples provide an infrastructure including at least three layers: data collection, system intelligence, and data interoperability. An example data collection layer includes one or more electronic repositories that record patient care from a plurality of perspectives including clinical (e.g., EMR, personal health record (PHR), electronic health record (EHR), etc.) and administrative (e.g., revenue cycle, claims, etc.) perspectives. System intelligence includes a rules-based workflow that enables leveraging of clinical and operational guidelines and policies throughout the care process, for example. Data interoperability includes standards-based HIE technology to enable data, workflow and applications to be accessible across a community of care, for example.

An EMR, for example, creates a “living” electronic record of patient encounters over time, iteratively adding data on patient demographics and problems, clinician notes, treatment recommendations, medications, vital signs, and other information. An EMR can include functionality that uses these data to enhance care, such as computerized order entry and clinical decision support.

Electronic revenue cycle systems manage patient appointments, reminders and referrals, and insurance status. This functionality can include verification of a patient's insurance eligibility and terms of coverage, and can support digital submission, tracking, and remittance of healthcare insurance claims, for example. As a secure, efficient way to manage healthcare events and transactions, such systems can help providers increase claim accuracy, reduce operational costs, and improve cash flow, for example.

An EMR and revenue cycle system can be integrated in one application or closely linked via interfaces. Together they form a robust “starter set” of data sources that can provide a comprehensive view of patient encounters, documenting everything from symptoms and diagnoses to lab results and medications to appointments, referrals, insurance eligibility, and claims tracking. This rich data source enables stratification of the patient population, helping providers properly identify highest risk or highest cost patients and those most in need of dedicated care management, for example.

Decision support (e.g., driven by evidence-based medicine) and analytics (e.g., powered by cost/quality reporting) can be provided by an infrastructure that organizes large collections of data, applies the data to evidence-based algorithms and rules, and then delivers information in a user-friendly manner. Evidence-based medicine can be translated into clinical decision support (CDS), formalized “order sets”, and quality metrics, for example. System intelligence tools can be implemented through portals and/or as part of an EMR, for example.

Quality measures enable care delivery organizations to assess their progress. Quality measures can be used internally to link with CDS and create cycles of quality improvement, for example. Quality measure can also be used externally to establish accountability, demonstrate value, and provide a basis for system-wide enhancements, for example.

Organizing data from quality and cost measures allows timely access and monitoring of key performance indicators, staff productivity, and service utilization. Certain examples provide dashboards and sharable reports to support effective population health management.

In certain examples, a standards-based, two-way HIE technology can eliminate gaps between local EMRs by creating, in effect, a universal conduit that allows patient information to be shared quickly and transparently among institutions, providers, and patients. HIE connects the disparate systems across communities, aggregating data and images to enable safer, quicker, more informed decisions at a point of care. With transparency to each corner of the health system, HIE sets the table for the wide adoption of improved care processes, for example.

A standards-based system can provide predictability to enhance measurement, repeatability, reproducibility, etc. A standards-based system can support collaboration by allowing more providers to “plug and play” in the network. A standards-based system can help prevent “lock in” by helping a care delivery organization avoid being tied to custom solutions. A standards-based system can help reduce costs through lower installation expenses and total cost of ownership, for example.

With care management technology, users can collect and analyze data to identify high-risk patients, personalize care plans, coordinate care team workflow, and make programmatic improvements, for example. Care management can be provided by one or more applications associated with the system intelligence and information exchange platform, for example.

In concert with an EMR, revenue cycle software, and HIE, a care management solution can assist healthcare organizations in a number of ways. A care management system enables stratification and predictive modeling to identify patients who are at higher risk for developing serious diseases—potentially enabling earlier intervention to limit the severity of the disease and the cost of care. Combining information on individual patients with evidence-based guidelines, case managers can optimize or improve care plans and more easily coordinate the activities of primary care professionals, clinical specialists, home health workers, and others. Such coordination is important since chronic patients often have multiple co-morbidities and a corresponding high number of caregivers and potential care plans. Care management analytics can enable providers to identify gaps and opportunities in their programs for at-risk patients, leading to quality and cost management improvements.

A care management system helps produce an evolving care plan to support population health management, for example. As a patient's data enters the system from multiple sources over time, the care plan evolves to address the current health status of the patient. Caregivers can access a centralized care plan via HIE with an ability to develop and revise appropriately to the patient's changing health profile. Thus, a holistic approach may be taken to the patient's care rather than a sum of individual plans developed by individual providers.

Thus, certain examples provide population health management by replacing fragmented, episodic care delivery with a holistic, coordinated approach that improves health outcomes and experience of care for the population served, while lowering per capita costs. Certain examples provide a platform that supports collection and storage of pertinent data on patients, providers and payers, integrates system intelligence to enable evidence-based decisions, and enables smoother handoffs of information among team members.

With such a healthcare information platform in place, providers can leverage advanced applications to further enhance their services, such as care management to optimize care plans for chronically ill patients, utilization management to manage medical and pharmaceutical use, and referral management to better track patient encounters against individual care plans and organizational strategies. Certain examples help a healthcare organization to create an integrated community of care that can improve population health, reduce waste and inefficiency, address patient and caregiver needs, and control costs.

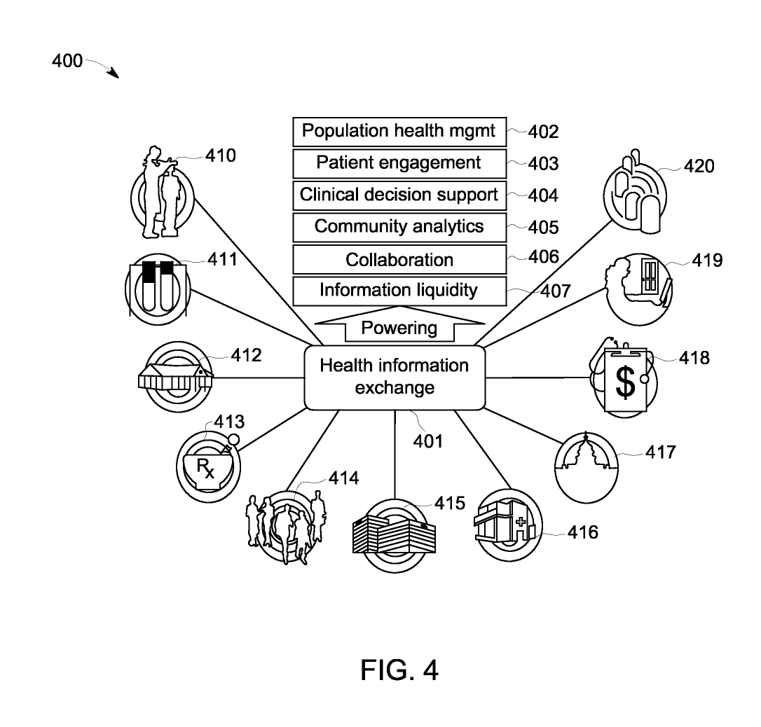

FIG. 4 illustrates an example community of care 400 built around an HIE 401 foundation. The HIE 401 takes a variety of inputs to facilitate population health management 402, patient engagement 403, clinical decision support 404, community analytics, 405, collaboration 406, information liquidity 407, etc. Actors who can provide input and/or utilize output include a primary care physician 410, lab 411, long term care and nursing 412, pharmacy 413, specialty practice 414, academic medical center 415, community hospital 416, government 417, payer 418, patient 419, other HIE 420, etc.

The system 400 provides a standards-based information exchange of electronic data which is consumable for analysis, data exchange, triggering decision support and/or workflows, etc. Information exchange brings together stakeholders from the community of care 400 and enables data liquidity, for example. Standardization and codification of data from sources allows that data to be aggregated, analyzed, and consumed by disparate systems. Certain examples provide an ability to collaborate with other clinicians about patients in a meaningful way, as well as provide opportunities for more comprehensive and community-level analytics and decision support, versus non-robust local reporting and decision alerts. The exchange 400 enables dissemination and collection of data to and from patients for engagement and management of the health of a patient and of a patient population, for example.

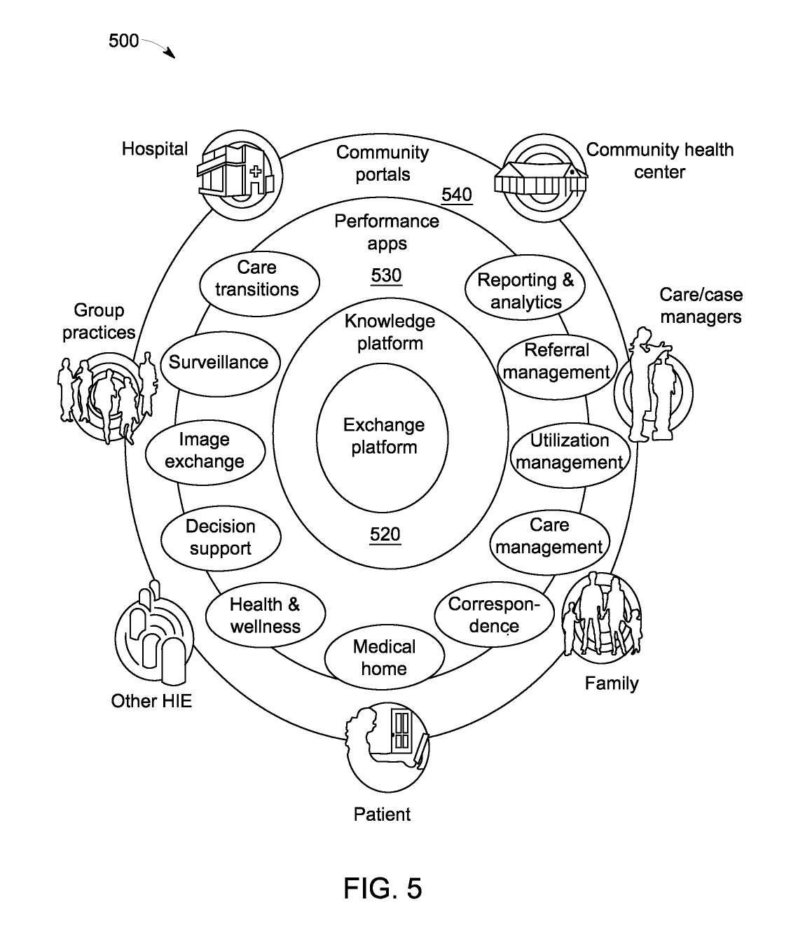

Viewed another way, as illustrated in the example of FIG. 5, connecting a community of care to enable knowledge and action starts with information liquidity, which leads to the access of knowledge and intelligence, eventually enabling delivery of performance applications that enable care delivery across the community.

As shown in the example system 500 of FIG. 5, an HIE can provide an exchange platform 510 to create data liquidity through standardization, for example. With the information liberated, that information can now be transformed into intelligence and insight in a context of current scientific knowledge and processes. For example, for population health, a care pathway is typically followed by care managers who are managing patients with certain poly-chronic diseases. Those evidence-based care pathways are instantiated into a knowledge platform 520 as rules that trigger workflows and tasks for care managers to follow in order to care for their patient populations, for example. Standardized information from the exchange platform 510 combined with the knowledge platform 520 can provide many other outcomes and support, for example. In order to push this power out to users across the community, performance applications 530 are provided that interface with users via one or more community portals 540. Applications 530 can be one or more modular applications that deliver high value functions by leveraging rules and clinical knowledge in conjunction with community-wide data to deliver functionality that extends beyond an episode of care, for example.

For example, performance applications 530 can include reporting and analytics, referral management, utilization management, care management, correspondence, medical home, health and wellness, decision support, image exchange, surveillance, care transitions, etc. Community portals 540 can include a hospital portal, community health center portal, care and/or case manager portal, family portal, patient portal, group practice portal, other HIE portal, etc.

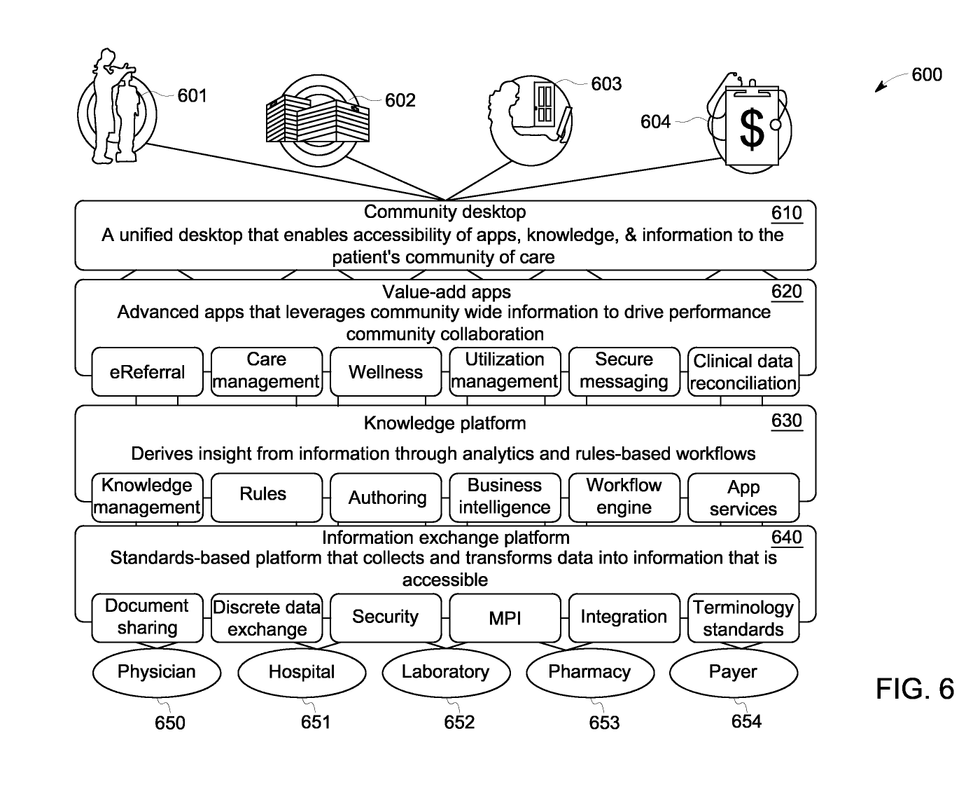

FIG. 6 illustrates an example population health management system 600. The example system 600 interacts with a plurality of users 601-604, such as primary care physician/case manager 601, provider 602, patient 603, payer 604, etc., via a unified desktop 610. The unified or community desktop 610 enables accessibility to applications, knowledge, information, etc., in a patient's community of care, for example.

Via the desktop interface 610, a user can facilitate population health management to stratify and assess patient data, refer patients, manage a patient population, etc. Timely and holistic data of a patient and patient population can be provided, for example. Real-time (or substantially real time given data transmission, processing and/or storage delay) community data can provide a holistic view of a patient's current status, for example. Communication and collaboration can be coordinated via the interface 610 and associated applications 620, including hand-off between care providers and/or other care team members, for example. Evidence-based guidelines and policy-driven workflows can be provided through a rules-based system 600. Analytics and reporting of outcomes, quality indicators, staff productivity, benefit utilization, etc., provide insight into a population and community of care, for example. Knowledge and information exchange platforms 630, 640 help to share pertinent information on patient, employer, provider, etc.

Via the desktop interface 610, a user can access one or more applications 620. The applications 620 leverage community-wide information to drive performance and community collaboration, for example. Applications 620 can include electronic referral (eReferral), care management, utilization management, health and wellness, patient online, analytics, secure messaging, clinical data reconciliation, etc. A knowledge platform 630 and information exchange platform 640 can be leveraged to support the applications 620 with respect to a patient and/or population, for example.

The knowledge platform 630 derives insight from information through analytics and rules-based workflows, for example. The knowledge platform 630 can include stratification, rules engine, task engine, workflow engine, business intelligence/analytics, engine, care pathways/evidence-based medicine, application services, authoring, etc.

The information exchange platform 640 provides a standards-based (e.g., Integrating the Healthcare Enterprise or IHE standards-based) platform that collects and transforms data into information that is accessible, for example. The information exchange platform 640 can include a data and image exchange, document sharing, master patient index (MPI), aggregated data store, secure messaging and/or longitudinal record access (e.g., DIRECT plus), integration adapters, terminology, etc. One or more sources, such as a physician 650, hospital 651, laboratory 652, pharmacy 653, payer 654, etc., can provide information to the information exchange 640.

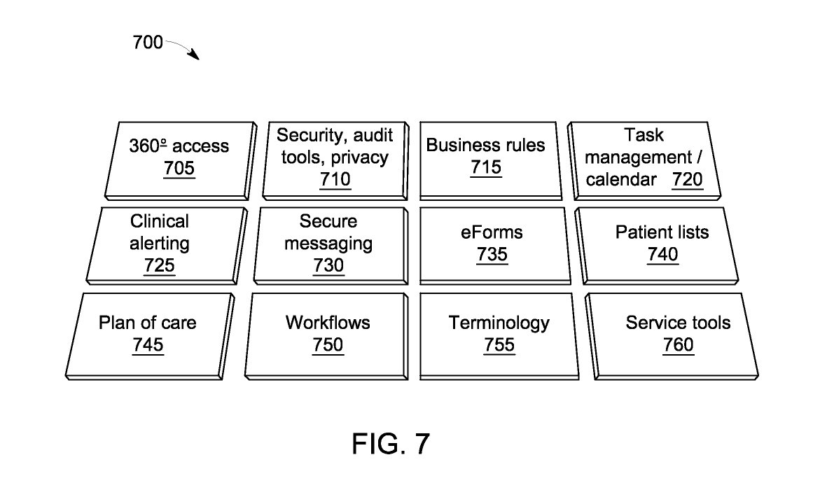

As shown in the example of FIG. 7, a population health management system 700 provides care management via 360 degree data access 705, security/audit/privacy tools 710, business rules 715, task management/calendar 720, clinical alerting 725, secure messaging 730, electronic forms 735, patient list(s) 740, plan of care 745, workflow(s) 750, terminology 755, service tools 760, etc. The system 700 provides a clinical record focused on discrete data and observations along with care management tools focused on the plan of care and an administrative record focused on claims and administrative transactions, for example. Task orchestration and management are also provided.

The example PHMS 700 facilitates care management and population health management through the integration of protocol management with an electronic health record to provide access and support for clinical, administrative, manager, system administrator, and service users, for example. Clinical users can interact with patient records via the system 700, for example. Non-clinical, administrative users can interact with patient records on a more limited basis than clinical users, for example. Manages can oversee and manage groups of administrative and clinical users via the system 700, for example. System administrators can manage user accounts and application configuration via the system 700, for example. Technical service administrators can manage back end connectivity and system configuration via the system 700, for example.

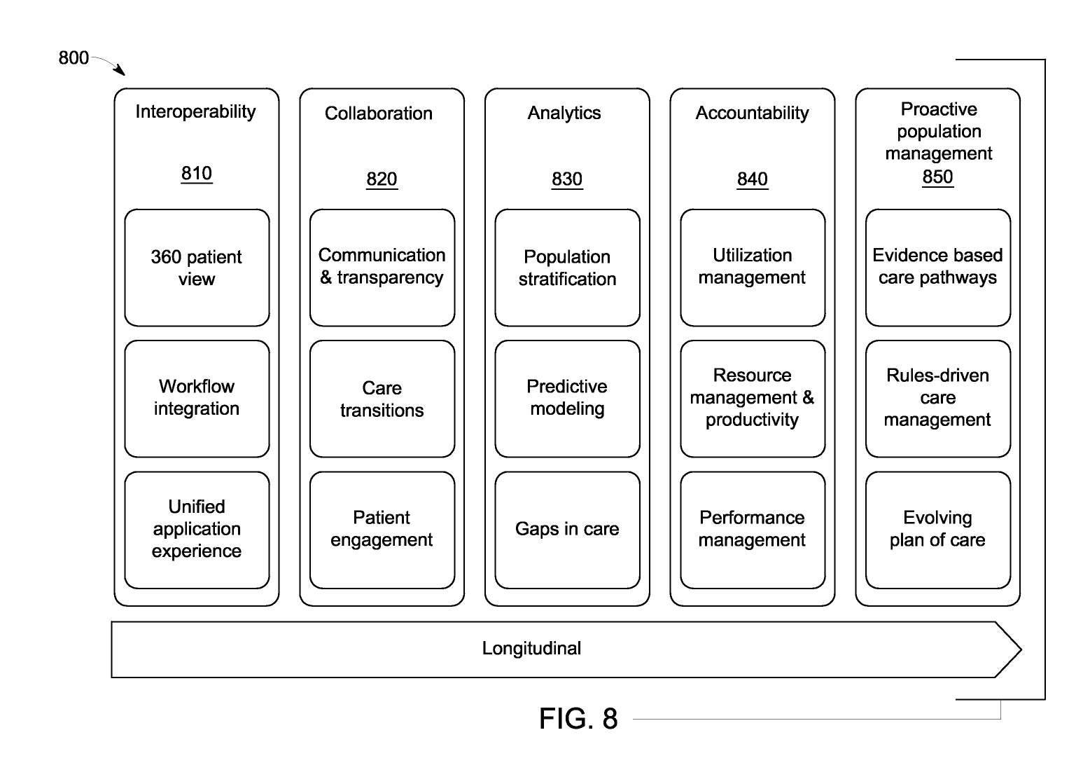

FIG. 8 illustrates an example population health management system 800. The system 800 of FIG. 8 provides interoperability 810, collaboration 820, analytics 830, accountability 840, and proactive population management 850, for example. The components of the example system 800 continuously (or substantially continuously) leverage information about patients from a longitudinal perspective, for example.

In the example system 800, interoperability 810 provides interoperability at a plurality of levels such as information, application, workflow, etc. Interoperability 810 helps to provide one patient, one record access to patient data, for example. Interoperability 810 helps to facilitate a unified application experience, for example. Interoperability 810 helps to provide an integrated workflow, for example. Information interoperability can be facilitated via an exchange across shareholders, for example. Unified viewing and workflow can be provided through a unified viewer of communication information and applications with configurable views and dashboards using portal technology, IHE profile, smart data aggregation, longitudinal portlet views, and robust workflow capability, for example.

In the example system 800, collaboration 820 helps to facilitate community collaboration and patient engagement through communication and transparency, care transitions, and patient engagement. Collaboration 820 provides secure messaging (e.g., provider to provider, provider to patient, etc.) to access and exchange messages and patient data, for example. Collaboration 820 provides care alerting such as by subscribing to a patient's care activity (e.g., an emergency room visit, hospital admission, etc.).

Care transition management can be facilitated through electronic referrals, for example. For example, a patient visits her primary care physician. The primary care provider (PCP) orders a specialist referral via his EMR. The EMR sends a referral order and clinical summary of the visit to an HIE. Next, a referral coordinator receives a task that a referral has been initiated. She uses an eReferral portal to initiate and manage the referral via the system 800. Completion of the visit is flagged via the eReferral portal. The referring clinician retrieves a referral report from the HIE. A specialist coordinator receives the referral request from the referral coordinator and collaborates with the referral coordinator to finalize the appointment. The specialist coordinator retrieves further information (e.g., clinical summary, labs, etc.) from the HIE as needed. The patient sees the specialist, and the specialist accesses referral information from the HIE via the EMR. The specialist uses his native EMR, and completes the visit. The EMR submits a specialist note as a continuity of care document (CCD) into the HIE. A user can select a view notes, labs, ancillary test results, medications, and other details associated with the patient's specialist visit, for example.

In the example system 800, analytics 830 and accountability 840 provide performance management and analytics to support population stratification, utilization management, etc. For example, analytics 830 provides patient population stratification, predictive modeling, care gap analysis, etc. Accountability 840 provides cost and utilization management, resource management and productivity measurement, guideline and standard-driven analysis, etc.

Performance management analytics provides a clinical and claims aggregated data store, for example, based on an information exchange gathering data from one or more sources such as registration (Admit, Discharge or Transfer (ADT)), lab and pharmacy, decision support, practice management, claims and remittances, electronic medical records, and/or other financial and clinical transaction systems. Analytics can be provided as one or more of dashboards and scorecards, reporting and analysis, interactive drill down, workflow intelligence, third-party data integration, proactive alerts, data visualization, business rules engine, role-based security, risk segmentation, benchmarking, document management, etc.

Medical management analytics helps identify opportunities for improved population health management, support accountable care, enable clinical integration, measure effectiveness of meaningful use and identify new meaningful use policies, analyze authorizations and pre-certifications, alert leadership to systematic gaps in care, etc. For example, meaningful use involves using healthcare technology and data to improve quality, safety, efficiency, and reduce health disparities; engage patients and family; improve care coordination, and population and public health; maintain privacy and security of patient health information; etc. Compliance with meaningful use may help provide better clinical outcomes; improved population health outcomes; increased transparency and efficiency; empowered individuals; more robust research data on health systems; etc.

Clinical performance management helps reduce clinical resource costs, increase service line margins, improve quality outcomes, and support accountable care, population health management, meaningful use, clinical integration, physician quality reporting, pay-for-performance, value-based purchasing, and other quality and/or cost containment initiatives, for example. Clinical performance management includes service line trend analysis, individual physician scorecard, resource utilization/cost analysis, patient satisfaction score, core measure analysis, physician cost and quality benchmarking, patient demographic analysis, and/or cost/margin analysis, etc.

In the example system 800, proactive population management 850 helps a provider manage and care for a population through care management, health maintenance and wellness, and evolving care plan. Aggregate population view(s) can be provided along with a patient list, for example. A community view of a patient can be provided. Problems, goals, and interventions can be connected, for example, to help attain population health management.

In certain examples, a population health management system provides a data integration layer to merge patient information with a variety of external systems, including claims and diagnostics data. The combined data is leveraged by the system to provide a real time (or substantially real time), objective view of the patient in conjunction with one or more health services applications tied together with business rules, decision support, analytics, and reporting, for example. An extensible portlet infrastructure can be provided with configurable user views based on user role and/or organization affiliation, for example.

In certain examples, a business process management (BPM) engine provides infrastructure and tooling to build customizable process activities and workflows which can then be executed using automated decisions, tasking and sequence flows, etc. Certain examples provide a business rules authoring environment to manage business rules and/or other logic across the system. Business rules can include policies, requirements, conditional statements, etc., used to determine tactical actions that take place in applications and systems, for example. A rules engine allows for execution of configurable business rules in a runtime production environment, for example. Business rules enable users to defined policies and operational decisions. The rules engine provides separation from application code such as by isolating how rules are defined, tested, executed, maintained, etc.

In certain examples, a task manager handles life cycle management of human tasks. The task manager accepts human tasks from the business process engine and/or other external system. The task manager provides a user interface to application users such as intake coordinators, medical management team, etc. The interface allows users to view and manage tasks assigned to them and their group, for example.

Certain examples facilitate creation of electronic forms via a configurable user interface screen. The form may present information to a user, allow a user to document information about a patient, etc. Data captured using electronic forms can be stored as a document, data in a database or other data store, etc. In certain examples, one or more electronic forms can be used to guide a user through a workflow or protocol presented as one or more paths for user navigation through one or more electronic forms. The user is able to navigate through the forms as a defined, stepped process and/or in a free-form, self-guided manner, for example. In certain examples, electronic forms (eForms) are provided to a user in a workspace including a workflow navigation space and an eForm presentation space. In certain examples, a user can create custom eForms for presentation to users in the system.

Certain examples provide terminology services by querying one or more knowledge bases and/or database tables. A knowledge base may be populated by one or more third party applications, for example.

In certain examples, an Aggregated Data Store (ADS) component serves as a consolidated data store for internal (e.g., PHMS) and external (e.g., Clinical, Claim, Pharmacy, Lab, Dental, Mental Health and others) data systems. The ADS is to provide clinicians and care managers with a comprehensive and transparent view of patients across healthcare functional areas, for example. In addition, ADS can support analytics, reporting, and stratification activities as well as feed ADS data into other external systems, such as for additional analytics, business intelligence, decision support activities, etc. Data stored in ADS can include information about organizations, providers and/or patients, but the ADS may not serve as the system of record for those entities. Rather, the ADS may be synchronized with the corresponding registries using interfaces provided by those registries.

Certain examples provide a plan of care component to assist a care manager to develop and maintain a patient's plan of care information that describes services and care to help remedy a patient's health problems. The plan of care includes clinical problems that the patient has as determined from the clinical assessment; goals that patient has to achieve in order to control the problem; interventions by the care manager or physician to assist the patient in achieving the goals; etc.

In certain examples, community, 360-degree access allows a user to launch external applications such as EMR, document repository, business management, etc. Depending upon capabilities of an application, one or more paths can be provided for application access, such as launching external applications without context, launching external applications with user context, launching external applications with user and patient context, starting external applications with user and patient context hosted within the PHMS application, etc.

Certain examples provide clinical alerting including a visual indicator for a user to identify if the value of an observation is or is not normal. Normal is described as falling within a reference range of that observation. Values that are outside of normal (either lower or higher) may be categorized as abnormal or critical, for example.

Certain example PHMS systems include numerous clinical and non-clinical consolidated views of patient data. Views include discrete codified data, discrete non-codified data, and documents, for example. The user is able to navigate through the data though use of organizational categories and then reorganize the data within the categories using system defined mechanisms such as filters and sorts, for example. A view may provide a global banner to view navigation and recent patient list, for example. A user home view provides access to patient lists, tasks, patient search, system administration, user preferences, and reporting, for example. A patient registration view allows new patients to be entered, for example. A clinical patient view includes one or more of diagnoses, medications, allergies, procedures, immunizations, family history, social history, review of systems, plan of care, vitals, task history, correspondence, document and observation viewer, patient notes, etc.

In certain examples, patient lists provide a view into clinical information for multiple patients enabling a clinician to gain a high-level understanding of the health of a population of patients in which the clinician is interested. Once the population has been defined, the user can select the view of the population of interest. Within a list, clinicians can perform a set of actions about a patient (e.g. open their chart) or on the entire list (e.g., print the list).

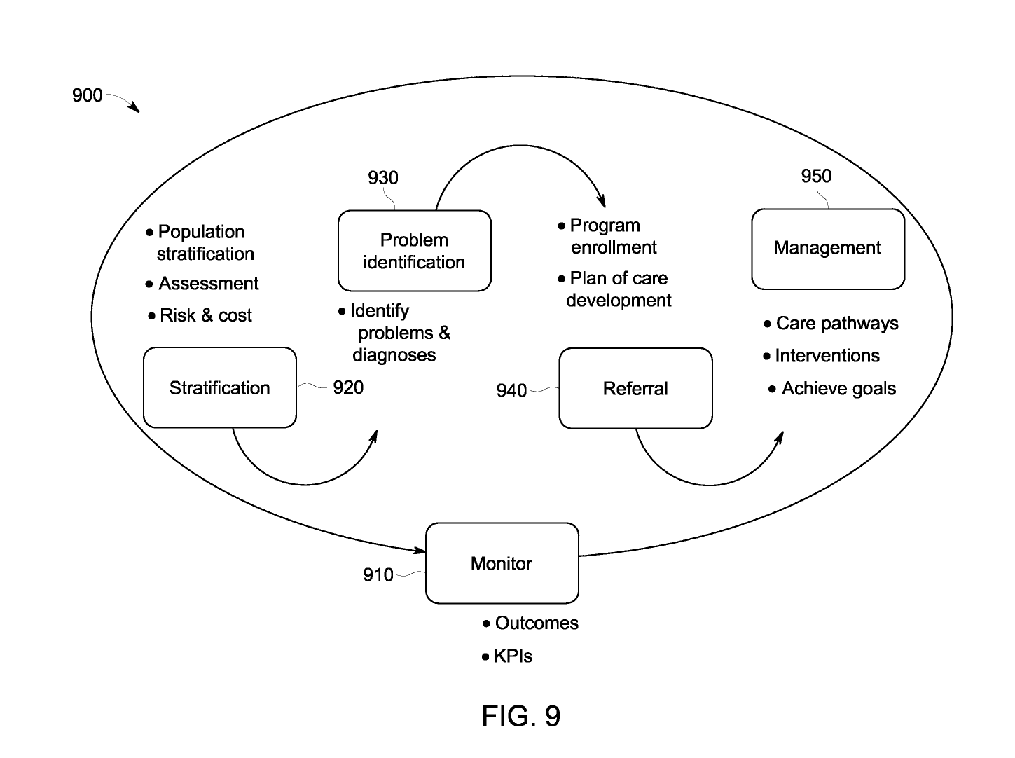

FIG. 9 depicts an example population health management cycle 900. The cycle 900 provides a monitoring 910 loop to monitor changes in patients, data, events, etc. The monitoring loop helps to orchestrate and capture relevant information about patients across the community, for example.

At block 920, patients and/or patient data is stratified. For example, patients are stratified to target services to groups and/or individuals based upon their needs, cost and/or risk levels. At block 930, problems and/or diagnoses are identified. Identification helps in managing and coordinating patients across the continuum of care and helping patients to care for themselves. At block 940, a patient can be referred. Referral can facilitate program enrollment, plan of care development, etc. Referral can facilitate collaboration as well as engaging providers and patients to take action, for example. At block 950, care is managed. For example, care pathways are defined, interventions are scheduled, goals are set and achievement is monitored, etc. Performance at community, provider, and/or patient levels can be monitored 910, for example.

Thus, certain examples provide population health management through community collaboration, comprehensive population insight, an ability to care for patients in more proactive and holistic ways, etc. Community-wide intelligence, knowledge, and workflows based on data liquidity are provided. Certain examples enable collaboration and care coordination across a community. Certain examples provide accountability information for an individual or organization based on cost and associated care, as well as facilitate control through performance standards, outcome benchmarks, etc. Certain examples facilitate proactive population management rather than reactive episodic treatment. Certain examples help an organization engage patients in their care and the cost of their care.

In operation, for example, population health management systems and methods utilize a variety of individual, organizational, and cultural interventions to help improve the morbidity patterns (e.g., illness and injury burden) and health care use behavior of one or more defined populations. In contrast to disease management, population health management includes a plurality of chronic conditions and diseases, employs a single point of contact and coordination, and facilitates predictive modeling across multiple clinical conditions, for example. Example population health management systems and methods help enable coordination of the delivery of care across a population of patients to improve clinical and financial outcomes, through disease management, case management, and demand management. Example population health management systems and methods facilitate identification of a patient population and enable delivery and evaluation interventions, as well as care measurement and analytics.

Using population health management systems and methods, patients, providers, payers, and other practitioners can be engaged to share data (observant of HIPAA), facilitate multidisciplinary connection, provide interoperability and scalability, and learn from best practices and expanded care pathways, for example. With an HIE connecting a plurality of hospitals and providing a foundation for information liquidity (e.g., an ability or ease with which to provide/flow, leverage and/or convert information), population health management systems and methods provide a knowledge platform that converts information in the HIE into insight and intelligence. Based on that insight and intelligence, example systems and methods enable delivery of performance applications that address care delivery across the community (see, e.g., FIG. 5).

Example population health management systems and associated methods facilitate interoperability at all levels of a communication, such as information, application, and workflow (see, e.g., FIG. 8). As shown, for example, in FIG. 4, managing a population involves a variety of data types and an HIE that leverages a variety of transactions. Transactions and data include standard feeds such as HL& and IHE-based protocols. Transactions and data include also leverage other protocols such as HIPAA transactions (e.g., X12, etc.) and a conversion of data such as minimum data set 3.0 (MDS3) for long term care (LTC), scheduling information unsolicited (SIU) messages for scheduling, etc.

A unified viewer can facilitate access to community information and applications, as well as portal-enabled workflow access, longitudinal data views, configurable dashboards, etc. Such a viewer helps to encourage community collaboration and patient engagement, for example. Collaboration can be facilitated by secure messaging (e.g., provider-to-provider, provider-to-patient, etc.) and care alerting (e.g., subscribing to a patient's care activity such as emergency department visit, admitted to a hospital, etc.), for example. Care transition management can also be facilitated through electronic referrals between a primary care physician, a referral coordinator, a specialist coordinator, and a specialist, for example.

In certain examples, a patient portal provides a single online channel of communication to increase patient engagement by extending a provider workflow into a patient's home. As a result, improved patient engagement and access to information helps to reduce care cost, increase care quality, and increase access to care, while extending proactive care management and improving efficiency, for example.

Certain examples provide performance management and analytics through population stratification and resource utilization management (see, e.g., FIG. 8). In certain examples, population health management systems and associated methods provide performance management analytics, such as dashboards and scorecards, reporting and analysis, workflow intelligence, data visualization, risk segmentation, benchmarking, business rules, role-based security, proactive alerts, third-party data integration, interactive drill down into data, document management, etc., in conjunction with an aggregated data store of clinical and claims information, as well as an image exchange communicating with multiple systems (e.g., registration, lab, pharmacy, decision support, practice management, claims and remittances, electronic medical records, other financial and clinical transaction systems, etc.). In certain examples, medical management analytics are also provided to manage healthcare utilization and quality more effectively.

In certain examples, a clinical performance manager helps reduce clinical resource costs, increase service line margins, improve quality outcomes, and support accountable care, population health management, meaningful use, clinical integration, physician quality reporting, pay-for-performance, value-based purchasing, and/or other quality and cost containment initiatives. The example manager provides features such as service line trend analysis, individual physician scorecards, resource utilization/cost analysis, patient satisfaction scores, core measures analysis, physician cost and quality benchmarking, patient demographic analysis, cost/margin analysis, etc.

In certain examples, proactive population management helps provide patients and providers with evolving care plans to promote health maintenance and wellness as well as care management (see, e.g., FIG. 8). A patient or provider can be provided with a single user home page for care management, for example. In certain examples, population views and a patient list can be provided via a panel in the aggregate. Further, a community view of a patient can be provided, even leveraging legacy systems, for example. Through a coordinated plan of care, population health management systems and methods can help connect problems and provide goals and interventions to promote population health.

While certain examples have been illustrated and described, one or more of the elements, processes and/or devices illustrated in may be combined, divided, re-arranged, omitted, eliminated and/or implemented in any other way. One or more elements, processes and/or devices may be implemented by hardware, software, firmware and/or any combination of hardware, software and/or firmware. For example, one or elements, processes and/or devices can be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one element is hereby expressly defined to include a tangible computer readable medium, such as a memory, Blu-ray, digital versatile disk (“DVD”), compact disc (“CD”), etc., storing the software and/or firmware. Further still, elements, processes and/or devices disclosed in the examples described herein may include one or more elements, processes and/or devices in addition to, or instead of, those illustrated, and/or may include more than one of any or all of the illustrated elements, processes and devices.

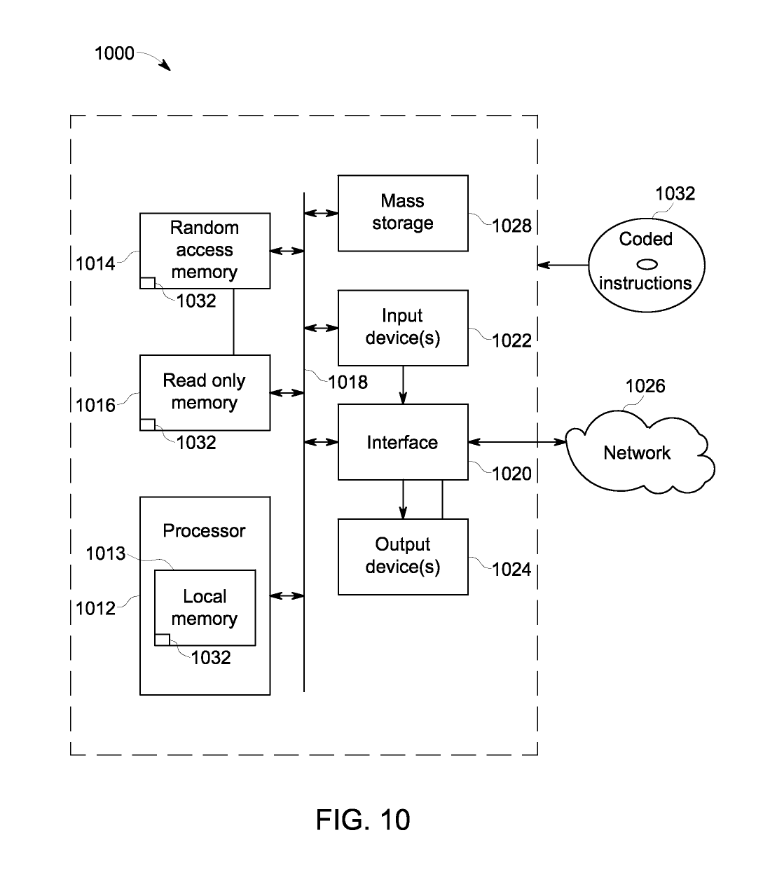

Flowcharts representative of example machine readable instructions for implementing systems and methods described herein are shown in FIGS. 3 and 9, for example. In these examples, the machine readable instructions comprise a program for execution by a processor such as the processor 1012 shown in the example processor platform 1000 discussed below in connection with FIG. 10. The program may be embodied in software stored on a tangible computer readable medium such as a compact disc read-only memory (“CD-ROM”), a floppy disk, a hard drive, a digital video disc (DVD), Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 3 and 9, many other methods may alternatively be used. For example, the order of execution of the blocks may be changed, and/or some of the blocks described may be changed, eliminated, or combined.

As mentioned above, the example processes of FIGS. 3 and 9 may be implemented using coded instructions (e.g., computer readable instructions) stored on a tangible computer readable medium such as a hard disk drive, a flash memory, a read-only memory (“ROM”), a CD, a DVD, a Blu-Ray, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 3 and 9 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 10 is a block diagram of an example processor platform 1000 capable of executing instructions and/or otherwise implementing systems, methods, devices, etc., described herein. The processor platform 1000 can be, for example, a server, a personal computer, an Internet appliance, a set top box, or any other type of computing device.

The processor platform 1000 of the instant example includes a processor 1012. For example, the processor 1012 can be implemented by one or more microprocessors or controllers from any desired family or manufacturer. The processor 1012 includes a local memory 1013 (e.g., a cache) and is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 also includes an interface circuit 1020. The interface circuit 1020 may be implemented by any type of interface standard, such as an Ethernet interface, a universal serial bus (USB), and/or a PCI express interface.

One or more input devices 1022 are connected to the interface circuit 1020. The input device(s) 1022 permit a user to enter data and commands into the processor 1012. The input device(s) can be implemented by, for example, a keyboard, a mouse, a touchscreen, a track-pad, a trackball, isopoint and/or a voice recognition system.

One or more output devices 1024 are also connected to the interface circuit 1020. The output devices 1024 can be implemented, for example, by display devices (e.g., a liquid crystal display, a cathode ray tube display (CRT), etc.). The interface circuit 1020, thus, typically includes a graphics driver card.

The interface circuit 1020 also includes a communication device such as a modem or network interface card to facilitate exchange of data with external computers via a network 1026 (e.g., an Ethernet connection, a digital subscriber line (DSL), a telephone line, coaxial cable, a cellular telephone system, etc.).

The processor platform 1000 also includes one or more mass storage devices 1028 for storing software and data. Examples of such mass storage devices 1028 include floppy disk drives, hard drive disks, compact disk drives and digital versatile disk (DVD) drives. The mass storage device 1528 may implement a local storage device.

The coded instructions 1032 of FIG. 3 and/or 9 may be stored in the mass storage device 1028, in the volatile memory 1014, in the non-volatile memory 1016, and/or on a removable storage medium such as a CD or DVD.

Although certain example methods, systems, apparatus, and articles of manufacture have been described herein, the scope of coverage of this patent is not limited thereto. On the contrary, this patent covers all methods, systems and articles of manufacture fairly falling within the scope of the claims of this patent.

What is claimed is:

1. A population health management system comprising:
an information exchange platform to share of information for patients and providers in a selected population, the information exchange platform to collect and transform the information into an accessible, sharable format;
a knowledge platform to derive insight from the collected and transformed information, the knowledge platform to facilitate application of one or more analytics and rules-based workflows to the collected and transformed information to derive insight;
one or more applications to coordinate communication and care collaboration across the selection population based on the insight and information; and
a user portal to provide a unified interface to enable access to the one or more applications, knowledge platform, and information for the selected population.

2. The system of claim 1, wherein the information exchange platform comprises one or more of a data and image exchange, an aggregated data store, a terminology, a master patient index, and an integration adapter.

3. The system of claim 1, wherein the knowledge platform comprises one or more of a rules engine, a task engine, a workflow engine, an analytics engine, a patient stratification engine, and a care pathways engine.

4. The system of claim 1, wherein the one or more applications further comprises one or more of an electronic referral application, a care management application, a utilization management application, a health and wellness application, a patient online application, and an analytics application.

5. The system of claim 1, wherein the user portal is to facilitate collaboration, care alerting, and care transition via the unified interface.

6. The system of claim 1, wherein the user portal further comprises a plurality of user portals including a patient portal, a provider portal, a hospital panel, and a family portal.

7. The system of claim 1, wherein the information exchange platform, the knowledge platform, and the one or more applications combine to provide: a) interoperability through a single patient record, unified application experience, and integrated workflow; b) collaboration through management of care transitions, patient engagement, and transparent communication; c) analytics through population stratification, predictive modeling, and identification of gaps in care; d) accountability through utilization management, performance management, and resource management;
and proactive population management through application of evidence-based care pathways, rules-driven care management, and care plan evolution.

8. The system of claim 1, wherein the user interface is to facilitate collaborative access to a patient, a payer, a case manager, and a hospital.

9. A computer readable storage medium including instructions to be executed by a processor, the instructions, when executed, to implement a population health management system, the system comprising:
an information exchange platform to share of information for patients and providers in a selected population, the information exchange platform to collect and transform the information into an accessible, sharable format;
a knowledge platform to derive insight from the collected and transformed information, the knowledge platform to facilitate application of one or more analytics and rules-based workflows to the collected and transformed information to derive insight;
one or more applications to coordinate communication and care collaboration across the selection population based on the insight and information; and
a user portal to provide a unified interface to enable access to the one or more applications, knowledge platform, and information for the selected population.

10. The system of claim 9, wherein the information exchange platform comprises one or more of a data and image exchange, an aggregated data store, a terminology, a master patient index, and an integration adapter.

11. The system of claim 9, wherein the knowledge platform comprises one or more of a rules engine, a task engine, a workflow engine, an analytics engine, a patient stratification engine, and a care pathways engine.

12. The system of claim 9, wherein the one or more applications further comprises one or more of an electronic referral application, a care management application, a utilization management application, a health and wellness application, a patient online application, and an analytics application.

13. The system of claim 9, wherein the user portal is to facilitate collaboration, care alerting, and care transition via the unified interface.

14. The system of claim 9, wherein the user portal further comprises a plurality of user portals including a patient portal, a provider portal, a hospital panel, and a family portal.

15. The system of claim 9, wherein the information exchange platform, the knowledge platform, and the one or more applications combine to provide: a) interoperability through a single patient record, unified application experience, and integrated workflow; b) collaboration through management of care transitions, patient engagement, and transparent communication; c) analytics through population stratification, predictive modeling, and identification of gaps in care; d) accountability through utilization management, performance management, and resource management; and proactive population management through application of evidence-based care pathways, rules-driven care management, and care plan evolution.

16. The system of claim 9, wherein the user interface is to facilitate collaborative access to a patient, a payer, a case manager, and a hospital.

17. A method for population health management comprising:
providing access to accumulated patient data and associated analytics for a selected population in conjunction with one or more applications via a user portal;
monitoring a change in one or more of patient, data, and events based on the accumulated patient data and associated analytics captured from a plurality of sources in the selected population;
stratifying patients in the selected population into groups based on at least one of need, cost or risk;
identifying one or more problems and diagnoses associated with each of the stratified patient groups to facilitate management and coordination of patient care within each stratified group; and
facilitating management and coordination of patient care by enabling communication between patients and providers and definition of care pathways with associated goals.

18. The method of claim 17, further comprising facilitating electronic referral of a patient for at least one of program enrollment and care plan development.

19. The method of claim 17, further comprising monitoring outcomes and performance indicators based on the management and coordination of patient care.

20. The method of claim 17, wherein the method is facilitating via a combination of an information exchange platform to share of information for patients and providers in a selected population, the information exchange platform to collect and transform the information into an accessible, sharable format; a knowledge platform to derive insight from the collected and transformed information, the knowledge platform to facilitate application of one or more analytics and rules-based workflows to the collected and transformed information to derive insight; one or more applications to coordinate communication and care collaboration across the selection population based on the insight and information; and a user portal to provide a unified interface to enable access to the one or more applications, knowledge platform, and information for the selected population.
